(19) United States
(12) Patent Application Publication
(10) Pub. No.: US 2015/0307821 A1
(43) Pub. Date: Oct. 29, 2015

(54) PROCESS OF PRODUCTION OF LOW-CALORIE WINES

(71) Applicant: Justin BOGATY, Berryville, VA (US)

(72) Inventor: Justin BOGATY, Berryville, VA (US)

(21) Appl. No.: 14/262,950

(22) Filed: Apr. 28, 2014

(51) Int. Cl. C12G 1/00; C12G 3/08

(52) U.S. Cl. CPC C12G 1/00; C12G 3/08

(57) ABSTRACT

A wine production method is provided. The wine production method may be additive process producing predetermined reduction of calories of wine made from a base wine and resulting in a flavor which compares very favorably to the base wine. The wine production method may include providing a plurality of acidified water mixtures, such as but not limited to acidified pure water and/or acidified distilled water, that approximately match the acidity of the base wine. A portion of the plurality of acidified water mixtures may be added to the base wine so as to lower the overall total alcohol content, and so calorie content, thereof. The resulting low-calorie wine retains the taste and beneficial health properties of the base wine.

### BACKGROUND OF THE INVENTION

The present invention relates to methods of producing alcohol and, more particularly, to a method of producing low-calorie wine.

In recent years, numerous studies have illustrated the health benefits of moderate wine consumption. Meanwhile, the growing concern for health living has led to an increase in consumer demand for healthy products, for example, low-calorie beverages that do not depart from the taste of their full-calorie namesakes.

Currently, the process of manufacturing low-calorie wines has left a bitter taste in consumers' mouth. Either the process involves prohibitively expensive equipment, such as a centrifugal film evaporator and a reverse osmosis machine, or the process is a subtractive method of production resulting in less product volume and flavor. With subtractive methods you not only remove volume but also distort the components ratios found in wine. i.e 81% water found in normal wine would be higher, 12% alcohol found in normal wine would now be lower, 1.5% acid found in normal wine now would be lower and so on and so on. Therefore after the subtractive method is completed the wine would also have distorted taste. A third method of creating low-calorie wine involves harvesting of wine grapes before they either reach chemical maturity, acid maturity and or flavor maturity; each of these methods produce wines of lackluster taste. Specifically, low calorie wines has been made by harvesting grapes before maturity when the sugar content is less than that required for normal wine production. With less sugar, there is less alcohol and consequently, fewer calories. However, such early-harvest grapes have yet to reach chemical maturity, and so more than likely have also failed to reach phenolic maturity, leading to insufficient pH balances to make a fine wine: resulting in a wine that has been deemed by tasting panels as inferior.

As can be seen, there is a need for a cost-effective method of producing low-calorie wine that preserves the flavor and beneficial properties of traditional wines through an additive process.

### SUMMARY OF THE INVENTION

In one aspect of the present invention, a process of reducing the alcohol content of a base wine to produce a low-calorie wine having a substantial amount of its original taste comprises: measuring an alcohol content and an acidity of the base wine; calculating a dilution volume to achieve a new predetermined alcohol content by adding an acidified water mixture; forming the acidified water mixture having the substantially same acidity by combining a measured water and a plurality of wine acids; and mixing the dilution volume of the acidified water mixture to the base wine.

In another aspect of the present invention, a process of producing a low-calorie wine comprise: measuring an alcohol content of a base wine; measuring an acidity of the base wine; measuring the total acidity of each of a plurality of wine acids of the base wine; calculating a dilution volume by using a calorie formula to achieve a new predetermined alcohol content by adding an acidified water mixture; forming the acidified water mixture having the substantially same acidity by combining a measured water and each of the plurality of wine acids in substantially similar proportions as their respective total acidities measured in the base wine; mixing the dilution volume of the acidified water mixture to the base wine; and providing conventional filtering processes.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wine production method. The wine production method may be additive process producing predetermined reduction of calories of wine made from a base wine and resulting in a flavor which compares very favorably to the base wine. The wine production method may include providing an acidified water mixtures, such as but not limited to acidified pure water and/or acidified distilled water, that approximately match the acidity of the base wine. The acidified water mixtures may be added to the base wine by a predetermined dilution volume so as to lower the overall total alcohol content, and so calorie content, thereof. The resulting low-calorie wine retains the taste and beneficial health properties of the base wine.

Those skilled in the art appreciate that wine is a highly complex mixture of ingredients, the blend of which account for its unique taste or flavor characteristics. The major proportion of wine is of course made up of approximately 81% water. In addition, one generally expects to find, in these approximately percentages, the plurality of organic and inorganic wine compounds:

12% Alcohols

1.5% Plurality of Wine Acids such as tartaric, malic, citric, gallic, lactic and acetic acids;

1% Sugars like glucose, fructose and the like;

0.5% Sulfites;

1% Grape thaumatin like proteins and amino acids;

1% Vitamins (thiamin, riboflavin, vitamins A, B, K and G, folate, betaine, lutein, zeaxanthan);

1% Minerals (sodium, Calcium, iron, magnesium, potassium, zinc, copper, selenium);

1% Nutrients (Resvertrol, Flavonoids, Bioflavonids, phenolic compounds, tannins); and

Color pigments in a minor proportion.

Many of these organic and inorganic compounds, alone or in combination, give characteristic taste and flavor to the wine.

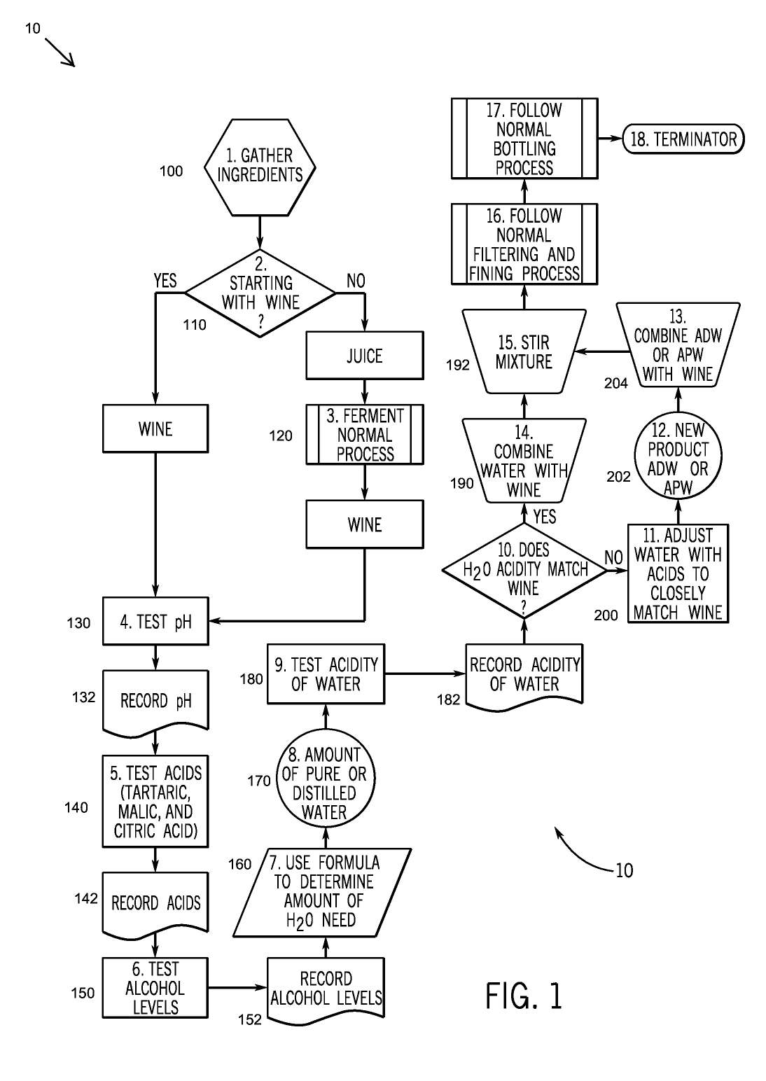

Referring to FIG. 1, the present invention may include a wine production method 10. The wine production method 10 may include adding an acidified water mixture to a base wine. The base wine may include fully matured grapes, grape juice, finished wine, a combination thereof or the like. The acidified water mixture may include but not limited to acidified pure water (APW) and/or acidified distilled water (ADW). The acidified water mixture may include portions of the plurality of wine acid so that the acidified water mixture acid levels or acidity approximately match the base wine acid levels. The combination of the acidified water mixture and the base wine may lower the overall total alcohol of a low-calorie wine, having fewer total calories as the base wine.

Calories in wine per serving may be calculated (but not limited to) by using a calorie formula:

Serving size (in grams)×alcohol %×7=Alcohol calories

Sugar level×glass size (in L)×4=Carbohydrates calories

Alcohol calories+Carbohydrates calories=Total Calories in a glass of wine.

The acidified water mixtures may be obtained by, but not limited to, the combination of the plurality of acid wines; namely, tartaric acid, malic acid and/or citric acid. The plurality of acid wines may comprise approximately 1.5% percent of the total components found in the base wine, and these components also constitute the three largest components after water and alcohol.

The wine production method 10 may be initiated by step 100, wherein a user gathers equipment and ingredients, the principal parts including but not limited to the base wine; the plurality of wine acids; a plurality of tanks; at least one mixer; at least one pH meter; at least one automatic titration system; water (pure or distilled); and at least one digital wine-alcohol refractometer. Method 10 may determine if the base wine includes a finished wine or a grape juice, in step 110. If the finished wine is chosen, method 10 proceeds to step 130. If the grape juice is chosen, method 10 proceeds to step 120. In step 120, method 10 may ferment the grape juice under normal wine production processes to produce the base wine. In step 130 and step 132, method 10 may measure and record the pH balance of the base wine. Then method 10 may measure and record total acidity and breakdown of the three main wine acids; tartaric acid, malic acid and citric acid of the base wine, in step 140 and step 142. In certain embodiments, step 140 and step 142 may measure all wine acid breakdowns of the base wine. Method 10 may measure and record the base wine total alcohol, in step 150 and step 152. Method 10 may then calculate dilution volume to achieve a predetermined alcohol content, and so calorie content by volume, for the new low-calorie wine by using the calorie formula, in step 160.

Method 10 may provide a measured water. The measured water may include purified water or distilled water in correct volume amount to achieve the predetermined alcohol content by volume for the new low-calorie wine, in step 170. It has been observed that tap water may contain chemicals, such as chlorine, that may could contaminate the final flavor of the wine or even be a precursor to TCA formation, also known as cork taint. Unpurified water may contain microbial that could cause the wine to spoil. Next, method 10 may proceed by measuring and recording of acidity of the measured water, in step 180 and 182. If acidity of water matches the acidity of the base wine, then method 10 may involve combining the measured water to the base wine and then mix, in step 190 and 192. Otherwise if the acidity of the measured water does not match the acidity of the base wine, then the method 10 may acidulate the measured water with approximately equal amounts of the plurality of wine acids, in step 200, forming the acidified water mixture with the approximate acidity of the base wine, in step 202. In certain embodiments, step 200 may use any combination of the plurality of wine acids to form the acidified water mixture with the approximately acidity of the base wine. In certain embodiments, step 200 may match the percentages of the three main acids—tartaric acid, malic acid and citric acid—of the base wine, as measured and recorded in step 140. and step 142, when forming the acidified water mixture. In certain embodiments, percentages of all measured wine acids may be used to form the plurality of acidified water mixtures 202. Then the acidified water mixture may be reduced to the dilution volume.

In step 204, the plurality of acidified water mixture may be added to the base wine, in step 204, and then mixed in step 192. Then method 10 may involve the normal filtering, fining and bottling processes before termination.

In certain embodiments, step 140 and step 142 may include measure and record at least one other wine compound, such as thaumatin, proteins, amino acids, mineral content and the like, of the base wine, and then add those components to the acidified water, in step 200, to form the acidified water mixture in step 202.

In certain embodiments, the acidified water mixture may be used as a cleansing water when tasting wine. When tasting wines people often use water to cleanse their palates between wines, however because of the massive pH and acid difference between water and wine the palate may to be ready for the next wine. That is why often people also use a cracker shortly after the tasting of water this is to bring the palate back to a normal range. The use may rinse their palate with a portion of the plurality of acidified water mixtures so as to balance the palate with the desired wine, thus allowing tasters to have a greater wine mouth feel.

It should be understood, of course, that the foregoing relates to exemplary embodiments of the invention and that modifications may be made without departing from the spirit and scope of the invention as set forth in the following claims.

What is claimed is:

1. A process of reducing the alcohol content of a base wine to produce a low-calorie wine having a substantial amount of its original taste comprising:
measuring an alcohol content and an acidity of the base wine;
calculating a dilution volume to achieve a new predetermined alcohol content by adding an acidified water mixture;
forming the acidified water mixture having the substantially same acidity by combining a measured water and a plurality of wine acids; and
mixing the dilution volume of the acidified water mixture to the base wine.

2. The method of claim 1, wherein the plurality of wine acids consists of tartaric acid, malic acid and citric acid.

3. The method of claim 1, further including measuring the total acidity of each of the plurality of wine acids in the base wine, and wherein the acidified water mixture combines each of the plurality of wine acids in substantially similar proportions as their respective total acidities measured in the base wine.

4. The method of claim 3, wherein the plurality of wine acids consists of tartaric acid, malic acid and citric acid.

5. The method of claim 1, further including measuring the percentages of a plurality of other wine compounds in the base wine, and wherein the acidified water mixture includes combining substantially similar relative proportions of the plurality of other wine compounds as measured in the base wine.

6. The method of claim 5, further including measuring each of the plurality of other wine compounds of the base wine as a percentage thereof, and wherein the acidified water mixture includes combining each of the plurality of other wine compounds in substantially similar proportions as measured in the base wine.

7. The method of claim 1, wherein the acidified water mixture consists of the measured water having substantially similar acidity as the base wine.

8. The method of claim 1, wherein the calculation of the dilution volume is based on a calorie formula.

9. The method of claim 1, further including using the acidified water mixture as a cleansing water.

10. The acidified water mixture of claim 1, wherein the acidified water mixture is used as a cleansing water.

11. A process of producing a low-calorie wine comprising:
measuring an alcohol content of a base wine;
measuring an acidity of the base wine;
measuring the total acidity of each of a plurality of wine acids of the base wine;
calculating a dilution volume using a calorie formula to achieve a new predetermined alcohol content by adding an acidified water mixture;
forming the acidified water mixture having the substantially same acidity by combining a measured water and each of the plurality of wine acids in substantially similar proportions as their respective total acidities measured in the base wine;
mixing the dilution volume of the acidified water mixture to the base wine; and
providing conventional filtering processes.

12. The method of claim 11, wherein the plurality of wine acids consists of tartaric acid, malic acid and citric acid.

13. The acidified water mixture of claim 11, wherein the acidified water mixture is used as a cleansing water.

14. The method of claim 11, further including using the acidified water mixture as a cleansing water.
